(19) United States
(12) Patent Application Publication
(10) Pub. No.: US 2006/0247989 A1
(43) Pub. Date: Nov. 2, 2006

(54) System and method for providing investment information

(76) Inventor: Tommasina A. Olson, Belmont, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/120,144

(22) Filed: May 2, 2005

(51) Int. Cl. G06Q 40/00

(52) U.S. Cl. 705/35

(57) ABSTRACT

The present invention includes a computer system for providing investment information. The computer system includes a server connected to a global network for collecting and disseminating information. The system collects information from third party sources, such as stock prices, financial performance, and news reports. The system also receives information from companies. The system provides guidance information for novice investors. The information from all the sources are organized into a single, simple user interface.

### BACKGROUND OF THE INVENTION

1. Field of the Invention

The present invention relates to a system and method for providing company information useful for investment purposes. More particularly, it relates to a system and method for providing, through a global computer network, and displayed in a user-friendly format, investment information from a variety of sources including company provided information.

2. Discussion of Related Art

In recent years, the number of people determining their own financial investments has increased significantly. The value of such investments has generally decreased. While investing in stocks used to be considered the province of the rich, individuals from all classes now regularly make investments. As individuals invest for their retirements, more interest has been generated in knowing, in more detail, the companies in which they are invested. With online and discount brokers, the costs relating to individual investments has also decreased.

In the area of financial investment, knowledge is power. The large numbers of new investors need access to information. Many also need basic information about the investment process and how to understand investment and company financial information. Such financial information has become more and more available due to the increase in computer communications and the use of global networks, such as the Internet and World Wide Web (“Web”). Many companies have information regarding their business, including its financial performance and direction on their own websites. Depending on the size of the company, these companies may or may not reach investors. Also, service providers of financial information have established informational sites on the Web. Other sites collect and display financial information from different third party sources. Financial news is readily available and can be searched with respect to specific companies.

Despite the abundance of financial and investing information, locating and understanding useful information can still be difficult. Investors routinely face the time consuming task of finding relevant information from among the overwhelming amount of information that is provided by the various information services. Such expenditure of time adversely affects the timely availability of information which may be crucial in decision-making. The costs associated with the time spent collecting information can be disproportionate to the stock prices, particularly for small and micro cap stocks. Additionally, information is often lacking for such companies. They do not have much press or analysts following the stocks. Often, much information is only available from the company. However, investment information sources rarely rely upon company provided information.

Additionally, most sources of investment information are designed for sophisticated investors. They provide facts and figures regarding performance and value without explanation or guidance. Newer investors are less experienced and need more explanations.

### SUMMARY OF THE INVENTION

The present invention provides a source for obtaining relevant investment related information from a variety of sources, including company provided information, third party information, and information explanations. According to one aspect of the invention, an investment information source collects information through a global computer network from a variety of sources. The investment information source then provides the information to potential investors through the global computer network. The sources from which the investment information source collects information includes from the companies being analyzed and third party sources of analytical and investment information.

According to another aspect of the invention, investing guidance information is provided by the investment information source. The guidance information includes a glossary of terms used with respect to the provided investment information. The guidance information further includes descriptions of the significance of the provided investment information.

According to another aspect of the invention, the investment information source includes a user interface for providing the information in a useful manner. The user interface may be graphical or textual based. The user interface allows a user to select a company and to receive the collected information relating to that company. The user interface allows the user to retrieve information provided by the company. The user interface also provides guidance information to assist a user in understanding the information and terminology on the website.

### BRIEF DESCRIPTION OF THE DRAWINGS

FIG. 1 is a block diagram of a computer network incorporating an embodiment of the present invention.

FIG. 2 is a first user interface according to an embodiment of the present invention.

FIG. 3 is a second user interface according to an embodiment of the present invention.

FIG. 4 is a partial user interface according to an embodiment of the present invention.

### DETAILED DESCRIPTION

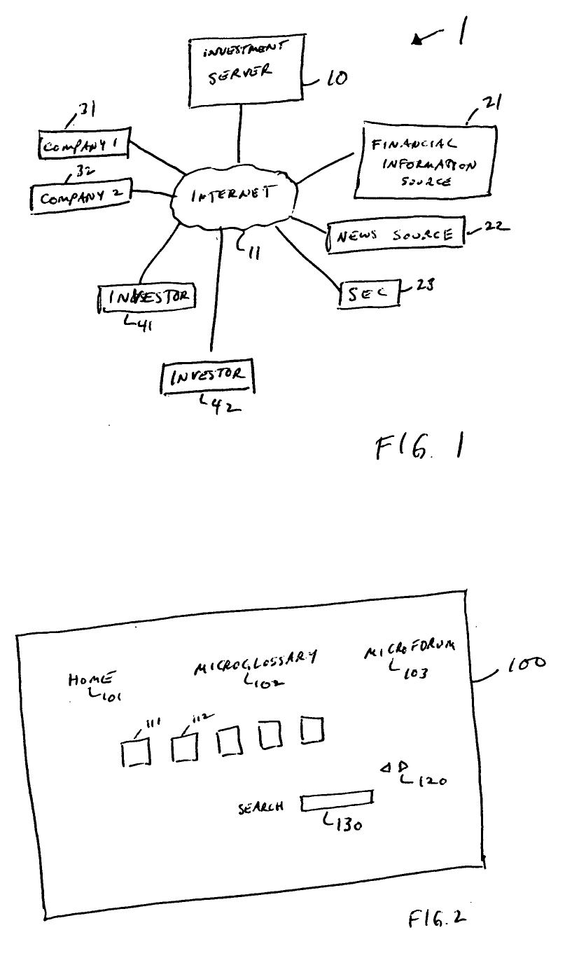

The present invention provides investment information in a simple, novice user friendly system, particularly suited for small and micro cap companies. The system is computer based operating of a global computer network such as the Internet or World Wide Web. The structure of the system 1 is illustrated in FIG. 1. The system 1 includes an investment server 10 dedicated to provide investment information to potential investors. The investment server 10 is connected to the Internet 11 or other computer network to provide a communication medium between the investment server 10 and the sources and recipients of investment information.

The system 1 retrieves investment information from a variety of computerized sources. The information server 10 can retrieve information from any source connected to the computer network. Such sources include financial information sources 21 and news sources 22. These sources are commonly used by existing investment information providers. The financial information may include stock prices (current and historical), financial results, and analysis information, such as earnings ratios and performance calculations. The system 1 may also collect public financial information from Security Exchange Commission (SEC) records 23. The new sources 22 may include API, Reuters, and other networks or sources of information.

In addition to public information sources, the system 1 collects information from specific companies 31, 32. The companies 31, 32 provide the information so that potential investors can make meaningful investment decisions. The system 1 provides a distribution mechanism for company information.

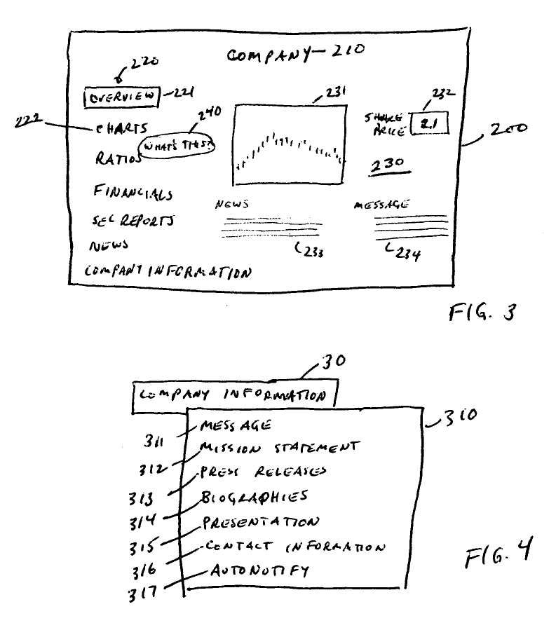

The system 1 further allows potential investors 41, 42 to access information in the investment server 10 through the computer network 11. Potential investors 41, 42 access the information through HTTP requests to the investment server 10. The investment server 10 provides the information in response to the requests. The investment server 10 includes a user interface for accessing the investment information. An embodiment of the user interface is illustrated in FIGS. 2-4. FIGS. 2 and 3 illustrate formats for web pages providing the investment information. Login and authentication procedures can be used to control access, either to add information or to receive it.

FIG. 2 illustrates an introductory web page 100 for selecting a company. The web page 100 is merely representative of the types of features included in the system of the present invention. Various selectable links provide access to certain types of information. With HTTP requests, the links include hyperlinks to other web pages within the system.

For example, the introductory web page 100 can be selected at any time using a HOME link 101. A GLOSSARY link 102 selects a web page (not shown) providing definitions for terms typically used in connection with investment information. The definitions may be set forth on the web page or may be provided on separate web pages. A search system can be used to find terms of interest, particularly if lots of terms are stored in the glossary. A FORUM link 103 is used to access one or more investment forums in which participants can exchange information relating to investments. Forums are set up and operated according to normal practice for computer networks.

Companies of interest are identified on the introductory web page 100. According to an embodiment of the invention, the companies are identified with their logos on selectable buttons 111, 112. The number of buttons 111, 112 depends upon the number of companies having information stored in the investment server 10. FIG. 2 illustrates the company buttons being positioned along a single row on the display. Multiple rows may also be use. When the number of companies in the system is such that the logos cannot be easily displayed on a single screen, additional web pages may be used for the logos. Or, companies may be grouped by industry and one link per industry will lead to a secondary page of logos. Navigation buttons 120 are used to browse the company logos so that the correct one may be selected. Additionally, a search function 130 can be used to find specific companies. Other structures may also be used to select a company. Other search functions, such as by share price, industry, and market cap, can be implemented to create a list of companies from which one can be selected.

When a company button 111, 112 is selected, investment information for that company is presented. FIG. 3 illustrates a web page for providing the investment information. FIG. 3 represents an overview page 200 for the investment information. It illustrates one method for representing the information about the company. Of course, the information may be presented in any reasonable manner. The name of the company 210 is displayed at to the top of the page. As illustrated in FIG. 3, a set of selectable links 220 provide access to different types of information. When a user clicks on a link, a new web page relating to the associated information is provided. The link 221 corresponding to the currently displayed page may be highlighted. The overview page basic information 230 from different sources, such as price charts 231, listings 233, share price 232, a company message 234. In addition to the overview page, information may be organized into charts, ratios, financials, SEC reports, News, and Company Information.

Various sources provide public information relating to investing. The present invention provides such information using similar processes, procedures, and operation. In addition, the present invention provides information from the company itself. This is particularly useful for potential investors in small and mid cap companies. Such companies are not often addressed by the media and have limited public information. While many companies have websites with similar information, the present invention collects all of the information for multiple companies into a single, easily accessible server. A further advantage is that by having both subjective (from the company) information displayed side by side with objective (third party) information, the investor has an ability to readily compare information.

FIG. 4 illustrates the type of company information 300 which can be provided to potential investors. The types of information are represented as a menu which appears on the display when the company information link is selected. The menu corresponds to certain web pages proving information. A message page 311 provides an automated video from the company to investors. A textual mission statement page 312 allows the company to identify its purpose. Press releases 313, that the company makes to the public are provided by the company. Biographies 314 of management or leading employees can also be provided. A Presentation 315 link accesses either a multi-media presentation by the company as a short video providing information about the company Or as the company's Power Point presentation. Contact information 316 for the company is provided.

The system 1 also allows personalization. If login processes are used, the presentations of the web pages may be personalized. The Autonotify/EmailMe! feature 317 under company information allows further personalization. A user can select certain companies in whom s/he is interested. When the selected Company adds any new information to the site an automatic email is generated to the interested investor's computer.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A system connected to a global computer network for providing information to investors comprising:
a data retriever for collecting public information relating to at least one company from public sources connected to the computer network;
a company information retriever allowing the at least one company to provide company information;
a memory for storing the public information and the company information;
a displayer for organizing the public information and company information into a format for display and for transmitting the organized public information and company information through the computer network for display to an investor.

2. The system according to claim 1,
wherein the at least one company includes a plurality of companies; and
the system further comprising a selector for receiving a selection of one of the plurality of companies from an investor through the computer network.

3. The system according to claim 1, further comprising a glossary defining terms used in at least one of the public information and the company information.

4. The system according to claim 3, further comprising links between the terms in at least one of the public information and the company information and the glossary.

5. The system according to claim 1, wherein the company information includes at least one of an audio presentation, a video presentation, and a multimedia presentation.

6. A method for providing information regarding companies to investors, the method comprising the steps of:
retrieving public information relating to at least one company from a public information source;
receiving company information relating to the at least one company from the at least one company;
displaying the public information and the company information.

7. The method for providing information regarding companies to investors according to claim 6, wherein the at least one company includes a plurality of companies, the method further comprising the steps of:
displaying a list of the plurality of companies; and
allowing an investor to select one of the plurality of companies; and
wherein the displaying step displays the public information and company information relating to the selected one of the plurality of companies.

8. The method for providing information regarding companies to investors according to claim 6, further comprising the step of:
providing glossary information relating to the meaning of terms in at least one of the public information and the company information.

9. The method for providing information regarding companies to investors according to claim 8, wherein the step of providing glossary information includes the steps of:
receiving a request from an investor identifying a term in at least one of the public information and the company information; and
providing a meaning for the identified term.

10. The method for providing information regarding companies to investors according to claim 6, wherein the company information includes at least one of an audio presentation, a video presentation, and a multimedia presentation.
